(19) United States
(12) Patent Application Publication
(10) Pub. No.: US 2007/0183992 A1
(43) Pub. Date: Aug. 9, 2007

(54) Cosmetic composition comprising porous particles incorporating optically active substances

(75) Inventors: Christophe Dumousseaux, Kawasaki-shi (JP); Tatsunari Goto, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: L'ORÉAL

(21) Appl. No.: 10/566,965

(22) PCT Filed: Aug. 5, 2004
(86) PCT No.: PCT/JP04/11626

§ 371 Date: Aug. 19, 2006

(30) Foreign Application Priority Data
Aug. 5, 2003 (JP) 2003-286827

(51) Int. Cl. A61Q 17/04

(52) U.S. Cl. 424/59; 514/770; 977/775

(57) ABSTRACT

An object of the invention is to offer an optical additive capable of adequately activating the effects of incorporated optically active substances, providing the base with such optical effects, having a suitable sensation and level of safety, and having exceptional cosmetic properties. A cosmetic composition comprising in a physiologically acceptable medium (a) silicium based porous particles having an aspect ratio of at least 2 and (b) an optically active substance incorporated into said porous particles is offered. The incorporated optically active substances are selected from among UV screening substances, fluorescent substances and photochromic substances.

### TECHNICAL FIELD OF THE INVENTION

The present invention relates to a cosmetic composition comprising an optically active substance such as a UV-absorbent or the like incorporated in silicium based porous particles. This cosmetic composition provides human skin with excellent optical effects, has a pleasant texture, and is safe to use.

### BACKGROUND ART

Cosmetic compositions for skin care and makeup often contain optically active substances consisting of various types of molecules or particles in order to provide optical effects on the skin where applied. Optical effects may include, for example, visible light diffusion, UV absorption, fluorescence and photochromism. For example, by including particles having strong diffusive reflection and light transmission properties, the matte (non-shininess) of the finish can be improved so as to make wrinkles and minor deformation of the skin less conspicuous. Substances having UV shielding effect protect skin from aging and deterioration. Additionally, molecules or particles having fluorescence and photochromic effects brighten the skin under certain light conditions to improve the appearance.

However, the use of these conventional optical substances in cosmetic compositions presents a number of problems. For example, the adhesiveness can deteriorate over time due to contact with perspiration and sebum, and these substances themselves often have problems in that they have inadequate adhesiveness to the skin, have a poor texture when applied to the skin, or are not safe for the skin.

As a solution to these problems, proposals have been made to encapsulate these optically active substances in spherical beads of metal oxides or polymers in order to overcome the problems of safety and texture. For example, Patent Document 1 describes spherical silica microparticles enclosing inorganic or organic coloring pigments. However, these spherical beads have poor adhesiveness to the skin when provided in cosmetic compositions. Additionally, spherical particles have problems in that cracks can occur when forming a powder foundation, they have a tendency to reduce mechanical strength, and have a limited range of possible use.

Additionally, Patent Documents 2 and 3 disclose the dispersion of metal oxide nanoparticles such as titanium oxide inside metal oxide flakes or glass flakes. While the cosmetic compositions containing these flake type particles have improved adhesiveness and spreadability on the skin, the optical properties of the incorporated metal oxide nanoparticles are not readily activated in the case of metal oxide flakes (Patent Document 2), and the UV screening effect due to titanium oxide nanoparticles is often insufficient in the case of glass flakes (Patent Document 3)
Patent Document 1: JP-A H6-47273
Patent Document 2: Japanese Patent No. 2591946
Patent Document 3: Japanese Patent No. 2861806

Therefore, an additive which is capable of adequately bringing out the effects of incorporated optically active substances, effectively provides the substrate with optical effects, has a good texture and safety, and has excellent cosmetic properties is needed.

### DISCLOSURE OF INVENTION

The present inventors discovered that at least part of the above-described problems can be resolved by incorporating at least one optically active substance into silicium based porous particles having an aspect ratio of at least 2.

By “optically active” it is meant that the substance is at least UV absorbing. The substance may have further optical properties such as visible light diffusibility, UV absorbability, fluorescent and/or photochromic capabilities.

That is, the present invention offers a cosmetic composition characterized by comprising in a physiologically acceptable medium, (a) silicium based porous particles having an aspect ratio of at least 2 and (b) an optically active substance incorporated into the porous particles.

In accordance with the present invention, the optically active substances such as UV absorbent substances are incorporated into silicium based porous particles, so that the active ingredients will never directly contact the skin to ensure safety. Additionally, they are in the shape of plates or needles, with good adhesiveness and spreadability on the skin. By using a silicium based material for forming the particles, the cosmetic composition forms a cosmetic film having extremely good transparence and a natural appearance after application. Since the silicium based particles are porous, they are able to efficiently absorb perspiration and sebum, thus improving the cosmetic hold and the diffusion of light due to the holes further improves the optical properties.

### BEST MODE FOR CARRYING OUT THE INVENTION

The silicium based porous particles used in the present invention is porous particles comprising silica as a main component, having an external shape of plates or needles and incorporating optically active substances such as UV absorbing substances.

The aspect ratio of the silicium based porous particles is at least 2, preferably at least 5. With an aspect ratio less than 2, the properties such as adhesion or spreadability of the cosmetic composition containing them may become insufficient. The upper limit of the aspect ratio is not particularly restricted and it may be determined in consideration of strength of the particles and the like.

The average grain size of the silicium based porous particles is 1-100 μm, preferably 2-50 μm, more preferably 5-20 μm. With a grain size of more than 100 μm, it becomes difficult for them to provide a satisfactory sense of use, and at less than 1 μm, the strength may be insufficient.

The average thickness of the silicium based porous particles is 100 nm to 5 μm, preferably 200 nm to 2 μm. If the thickness exceeds 5 μm, the sense of use and transparency are insufficient, and if the thickness is less than 100 nm, the mechanical strength tends to be inadequate.

The average pore size of the silicium based porous particles is 1-50 nm, preferably 2-20 nm. If the pore size is less than 1 nm, the diffusion of visible light becomes poor and almost no perspiration or sebum is absorbed. If the pore size is greater than 50 nm, the optically active substances contained therein are less likely to suffer from the effects of liquids present in the composition as well as perspiration and sebum.

The silicium based porous particles preferably have an oil absorbability of 50-500 ml/100 g, more preferably 70-200 ml/100 g. Silicium based porous particles having oil absorbabilities in this range can effectively absorb perspiration and sebum, and also protect incorporated active substances from solvents and the like contained in the cosmetic composition.

The optically active substances incorporated into the silicium based porous particles may be substances in which light causes physical and/or chemical effects, and may include UV screening substance, fluorescent substances and photochromic substances.

In the present invention, UV screening substances include substances having capabilities causing diffusion or scattering or reflecting UV rays in addition to absorbing UV rays.

The type of UV screening agent (including UV absorbent) used in the present invention is not particularly restricted as long as it is a substance that is normally used. For example, metal nanoparticles such as silver and metal oxide nanoparticles and the like can be named as inorganic substances having UV screening effects. The average grain size of the metal oxide nanopartides is preferably 1-300 nm, more preferably 5-50 nm. Specific examples of preferable metal oxides include titanium oxide, zinc oxide and cerium oxide. The UV screening substances may also be organic molecules. Examples of these include cinnamate derivatives, salicylate derivatives and p-aminobenzoic acid derivatives, camphor derivatives, benzimidazole derivatives, benzophenone derivatives, dibenzoylmethane derivatives and diphenylacrylate derivatives.

Examples of fluorescent substances include of derivatives of stilbene and 4,4′-diaminostilbene; derivatives of benzene and biphenyl; derivatives of pyrazines; derivatives of bis(benzoxazol-2-yl); coumarins; carbostyrils; naphthalimides, s-triazines; and pyridotoriazols.

Examples of photochromic substances include spirooxazines and derivatives thereof, naphthopyrane and derivatives thereof; spyropyrans and nitrobenzylpyridines. Additionally, metal nanoparticles with a grain size of about 1-100 nm interact with UV rays through plasma resonance absorption of surface electrons, thereby reducing the metal nanoparticle surfaces and causing discoloration. This effect is also considered to be included under photochromism. Silver nanoparticles are preferable.

With these optically active substances, it is possible to incorporate one type alone, or to combine two or more types. For example, the fact that a photochromic effect can be obtained by combining metal (e.g. silver) nanoparticles with metal oxide (e.g. titanium oxide) nanoparticles has recently been reported (Nature Material, 2, 1, pp. 29-31, January 2003).

Additionally, when blending the optically active substance as solid particles, their surface can be hydrophilized in order to improve the dispersibility of the particles in the production process using sol-gel method to be described below.

The amount of the optically active substances in the silicium based porous particles is not particularly restricted, and can be set as appropriate according to the intended use and type of optically active substance. Generally, silicium based porous particles holding about 5-40 wt %, preferably about 10-35 wt % of optically active substances will be used.

The silicium based porous particles as described above can, for example, be prepared by the sol-gel method starting from a silicon alkoxide solution. The sol-gel method is in itself a publicly known method, as described, for example, in Colloid Kagaku I Kiso oyobi Oyo (edited by Nippon Kagakukai, published by Tokyo Kagaku Dojin), pp. 387-399. In brief, an alcohol solution of a metal alkoxide such as tetraalkoxysilane or the like is formed into a colloid solution (sol) by mans of hydrolysis and a condensation polymerization reaction, and formed into a solid (gel) which has lost its fluidity due to further advancing the reaction, as a result of which porous particles can be produced.

Since the production of porous particles by the sol-gel method does not require the use of high temperatures (1000° C. or more) as in conventional glass production methods, substances which are susceptible to heat, such as organic molecules or the like, can be incorporated into the porous particles. Consequently, a wide range of optically active substances, including those listed above, can be incorporated. By appropriately selecting the production conditions, the substances can be incorporated while maintaining their physical and chemical properties.

In the present invention, the required optically active substance is added to the metal alkoxide solution during the sol-gel method to obtain porous particles incorporating the substance. The active substance can be dispersed by a publicly known method such as ultrasonic dispersion if needed.

Optionally, the porous particles obtained in this way is appropriately crushed and separated by size to obtain the silidum based porous particles used in the present invention.

In the present invention, it is also possible to directly use silicium based porous particles available on the market. For example, the silicium based porous particles sold by Nippon Sheet Glass under the name PTSG30A flakes contain 28% titanium oxide nanoparticles therein. The average grain size is 9.5 μm, the average thickness is 1.5 μm, the average pore size is 5 nm, and the oil absorbability is 140 ml/100 g.

The silicium based porous particles of the present invention may also be further surface-treated. The surface treatment may include a surface hydrophobicizing treatment, which can be performed according to publicly known methods. For example, surface treatments by silicone polymers, metal salts of fatty acids, amino acids or fluorine compounds are included.

The silicium based porous particles obtained in this way are blended into the cosmetic composition according to the usual methods. The content of the silicium based porous particles in the cosmetic composition is preferably 0.1-30 wt %, more preferably 1-20 wt % and most preferably 2-15 wt %. However, the amount is not necessarily restricted to these ranges, and can be appropriately determined by considering the intended effects such as the sensation on the skin, transparency, UV screening ability, and ability to cover up blemishes in the skin.

The “physiologically acceptable medium” is a medium conventionally used in cosmetics, which may be aqueous or non-aqueous and compatible with the skin scalp and mucous membrane.

In the cosmetic composition of the present invention, the sensation of use and the activated optical properties are preferably further improved by further adding a spherical powder.

The spherical powder to be added may be of an organic substance or an inorganic substance. Examples of spherical powders which are suitable for use include powders of silica, silica-based composite oxides, aluminum oxide, titanium oxide, zinc oxide, silicone resins, acrylate-based polymers, polyurethane-based polymers, nylon-12, polyethylene and polystyrene. Particularly preferable among spherical powders are porous nanospherules. Porous and non-porous spherical powders may also be used in combination.

These spherical powders are preferably blended into the cosmetic composition at a proportion of 0.1-30 wt %, preferably 1-10 wt %. The average diameter of the spherical powders is preferably 0.2-20 μm.

Aside from the silicium based porous particles and spherical powders mentioned above, the cosmetic composition of the present invention may contain other ingredients that are commonly used in cosmetics, such as oils, waxes, surfactants, polymers, preservatives, pigments, dyes, pearlescent agents, fillers, UV absorbents, water, humectants, chelating agents, fragrances, vitamins and active agents.

The cosmetic composition of the present invention, which contains silicium based porous particles incorporating optically active substances and arbitrary spherical powders, can be used in various types of skin care and makeup products. The cosmetic composition of the present invention can be in any form which is typical for cosmetics, such as emulsions, gels, sticks, and pressed or non-pressed powders.

The present invention shall be described in further detail by means of the non-limiting examples and comparative examples described below. The amounts given in the examples are all in units of wt %.

### EXAMPLE 1 AND COMPARATIVE EXAMPLES 1 and 2

Oil in water type creams were prepared with the following compositions.

TABLE 1

| | | Comp. | Comp. |
|---|---|---|---|
| | Ex. 1 | Ex. 1 | Ex. 2 |
| Phase I | | | |
| Cetyldimethicone copolyol/ | 9 | 9 | 9 |
| polyglyceryl-4-isostearate/ | | | |
| hexyl laurate | | | |
| Dimethicone | 5.4 | 5.4 | 5.4 |
| Cyclomethicone | 5.7 | 5.7 | 5.7 |
| Isododecane | 3.1 | 3.1 | 3.1 |
| Isostearyl Neopentanoate | 0.9 | 0.9 | 0.9 |
| Benton gel | 9 | 9 | 9 |
| Phase II | | | |
| Water | 48.6 | 48.6 | 48.6 |
| Butylene glycol | 6.3 | 6.3 | 6.3 |
| Magnesium sulfate | 0.9 | 0.9 | 0.9 |
| Preservative | qs | qs | qs |
| Phase III | | | |
| PTSG 30A Fake | 10 | — | — |
| TSG 30A Flake ¹ | — | 10 | — |
| Godball SQE 10C ² | — | — | 10 |

¹ Non-porous Glass flakes containing 28% titanium oxide nanoparticles (Nippon Plate Glass)
² Silica spheres containing 20% cerium oxide nanoparticles (Suzuki Oil and Fat)

Phase I and Phase II were separately mixed, then Phase II was added to Phase and stirred using a conventional homogenizer. Next, Phase III was mixed into the emulsion of Phase I and Phase II.

Data regarding the haze and total transmission were taken by measuring with an NDH 2000 hazemeter from Nippon Denshoku (see JIS K 7136). The transmission at a wavelength of 300 nm was measured using a V-550 spectrophotometer from JASCO. All of the measurements were made using an SPF silica cell (20 μm thickness) obtained from JASCO, on a film after drying for 10 minutes at 37° C.

TABLE 2

| | Total | | Transmission at |
|---|---|---|---|
| | Transmission (%) | Haze (%) | 300 nm (%) |
| Example 1 | 100.0 | 74 | 25.0 |
| Comparative | 99.2 | 60 | 46.6 |
| Example 1 | | | |
| Comparative | 97.3 | 57 | 34.7 |
| Example 2 | | | |

As is apparent from Table 2, the composition of the present invention (Example 1) has a much higher UV screening effect than in the cases where 20 non-porous glass flakes (Comparative Example 1) and non-porous silica spherical particles (Comparative Example 2) are used, and has good transparency which is at least equivalent to those of Comparative Examples 1 and 2. Furthermore, the haze is higher, which provides the resulting cosmetic with improved matte.

### EXAMPLE 2 AND COMPARATIVE EXAMPLE 3

Powder foundations were prepared with the following compositions.

TABLE 3

| | Example 2 | Comparative Example 3 |
|---|---|---|
| Talc | 35.8 | 35.8 |
| Sericite | 29.8 | 29.8 |
| Mica | 4.2 | 4.2 |
| Titanium oxide | 4.6 | 4.6 |
| Iron oxide | 1.87 | 1.87 |
| Zinc stearate | 0.85 | 0.85 |
| Liquid paraffin | 3.4 | 3.4 |
| Phenyltrimethicone | 4.25 | 4.25 |
| Preservative | qs | qs |
| Sunsphere H51 ³ | 5 | 5 |
| PTSG 30A flakes | 10 | — |
| Godball SQE 10C | — | 10 |

³ Porous silica spheres (Asahi Glass)

The composition of Comparative Example 3 was very difficult to press, and resulted in cracking and reduced mechanical strength in a compression pan. In contrast, the composition of Example 2 was able to be press-molded and had an appropriate level of strength. This product exhibited very good adhesiveness and spreadability on the skin, had a natural finish that lasted for a long time, and made fine lines and wrinkles on the skin to be hardly seen.

### EXAMPLE 3

A liquid foundation was prepared with the following composition.

TABLE 4

| | Ex. 3 |
|---|---|
| Phase I | |
| Cetyldimethicone copolyol/ | 8 |
| polyglyceryl-4-isostearate/ | |
| hexyl laurate | |
| Dimethicone | 4.8 |
| Cyclomethicone | 10 |
| Isododecane | 2.8 |
| Isostearyl Neopentanoate | 0.8 |
| Benton gel | 8 |
| Titanium oxide | 5 |
| Iron oxide | 1 |
| Phase II | |
| Water | 43.6 |
| Butylene glycol | 5.6 |
| Magnesium sulfate | 0.8 |
| Preservative | qs |
| Phase III | |
| PTSG 30A flakes | 5 |
| Sunsphere H51 | 2 |
| Plastic Powder D400 ⁴ | 2 |

⁴ Polyurethane-based spheres (Toshiki Pigment)

Phase I and Phase II were separately mixed, then Phase II was added to Phase I and stirred using a conventional homogenizer. Next, Phase III was mixed into the emulsion of Phase I and Phase II.

The composition of Example 3 exhibited very good adhesiveness and spreadability on the skin, had a natural finish that lasted for a long time, and made fine lines and wrinkles on the skin to be hardly seen.

1. Cosmetic composition comprising in a physiologically acceptable medium:
a) silicium based porous particles having an aspect ratio of at least 2, and
b) an optically active substance incorporated into said porous particles.

2. Cosmetic composition according to claim 1 characterized in that the aspect ratio is at least 5.

3. Cosmetic composition according to claim 1 or 2 characterized in that said porous particles are in the shape of plates or needles.

4. Cosmetic composition according to any one of claims 1 to 3 characterized in that the optically active substance is selected from the group consisting of UV-screening substances, fluorescent substances and photochromic substances.

5. Cosmetic composition according to claim 4 characterized in that the UV-screening substance is selected from the group consisting of metal oxide particles including particles of titanium oxide, zinc oxide and cerium oxide; derivatives of cinnamate; derivatives of salicylate; p-aminobenzoic acid derivatives; camphor derivatives; benzimidazole derivatives; benzophenone derivatives; dibenzoylmethane derivatives; diphenylacrylate derivatives; and metal nanoparticles including silver nanoparticles.

6. Cosmetic composition according to claim 4 characterized in that the fluorescent substance is selected from the group consisting of derivatives of stilbene and 4,4′-diaminostilbene; derivatives of benzene and biphenyl; derivatives of pyrazines; derivatives of bis(benzoxazol-2-yl); coumarins; carbostyrils; naphthalimides, s-triazines; and pyridotoriazols.

7. Cosmetic composition according to claim 4 characterized in that the photochromic substance is selected from spirooxazines and derivatives thereof, naphthopyrane and derivatives thereof; spyropyrans; nitrobenzylpyridines; and a combination of silver nanoparficles and titanium oxide nanoparticles.

8. Cosmetic composition according to any one of claims 1 to 7, characterized in that the silicium based porous particles flakes have an average particle size of 1 to 100 μm.

9. Cosmetic composition according to any one of claims 1 to 8, characterized in that the silicium based porous particles have an average thickness of 100 nm to 5 μm.

10. Cosmetic composition according to any one of claims 1 to 9, characterized in that the silicium based porous particles have an average oil absorbability of 50 to 500 ml/100 g.

11. Cosmetic composition according to any one of claims 1 to 10, characterized in that it further comprises a spherical powder.

12. Cosmetic composition according to claim 11, characterized in that the spherical powder is selected from powders of silica, silica-based composite oxides, aluminum oxide, titanium oxide, zinc oxide, silicone resins, acrylate-based polymers, polyurethane-based polymers, nylon-12, polyethylene and polystyrene.

13. Cosmetic composition according to any one of claims 1 to 12, characterized in that it is in the form of a skin-care product or make-up product.

14. Cosmetic additive consisting of an optically active substance incorporated in silicium based porous particles having an aspect ratio of at least 2.
